(19) United States
(12) Patent Application Publication
(10) Pub. No.: US 2019/0394716 A1
(43) Pub. Date: Dec. 26, 2019

(54) APPARATUS AND METHOD OF COMMUNICATION AND STORAGE MEDIUM

(71) Applicant: CANON KABUSHIKI KAISHA, Tokyo (JP)

(72) Inventor: Yuki Yoshikawa, Yokohama-shi (JP)

(21) Appl. No.: 16/559,309

(22) Filed: Sep. 3, 2019

Related U.S. Application Data
(63) Continuation of application No. PCT/JP2018/008578, filed on Mar. 6, 2018.

(30) Foreign Application Priority Data
Mar. 15, 2017 (JP) 2017-050373

(51) Int. Cl. H04W 48/16; H04W 52/02; H04W 8/00; H04W 56/00

(52) U.S. Cl. CPC H04W 48/16; H04W 56/001; H04W 8/005; H04W 52/0212

(57) ABSTRACT

A communication apparatus capable of transmitting or receiving a radio signal to or from another communication apparatus in a period of a predetermined length that comes at predetermined time intervals is controlled so as to transmit or receive a radio signal in part of a plurality of the periods and not to transmit or receive the radio signal in the remaining period, and if a response signal responding to the request signal transmitted to the other communication apparatus is not received, so as to receive the radio signal also in the remaining period.

### CROSS-REFERENCE TO RELATED APPLICATIONS

This application is a Continuation of international Patent Application No. PCT/JP2018/008578, filed Mar. 6, 2018, which claims the benefit of Japanese Patent Application No. 2017-050373, filed Mar. 15, 2017, both of which are hereby incorporated by reference herein in their entirety.

### TECHNICAL FIELD

The present invention relates to an apparatus and a method of communication and a program for the same.

### BACKGROUND ART

In recent years, wireless local area networks (LANs) typified by the IEEE802.11 series have been widely used. In most cases, a wireless LAN is controlled by a base station called an access point (AP). The AP and stations (STAs) in a wireless connection status within the radio wave coverage of the AP constitute a wireless network.

Not only such a conventional wireless network configuration constituted by an AP and STAs, products and specification standards of various wireless LAN networks have come on the market. PTL 1 discloses neighbor awareness networking (NAN) defined by Wi-Fi Alliance. The NAN is a standard that defines a mechanism for a communication apparatus to discover other devices and services that the other devices can execute. According to PTL 1, the NAN provides that the individual devices each transmit a beacon in a fixed period. Each device makes a communication in a fixed period and goes to sleep mode in the other period during which no wireless communication is performed, so that other devices and services can be discovered with low power consumption. According to PTL 2, some device that executes the NAN can discover other devices and services with lower power consumption by going to sleep mode also in part of the fixed period.

### CITATION LIST

### Patent Literature

PTL 1: U.S. Patent Application Publication No. 2015/0036540

PTL 2: U.S. Patent Application Publication No. 2016/0219422

Communication apparatuses can efficiently discover other devices and services with low power consumption by using the NAN, as described above. However, if a communication apparatus that goes to sleep mode also in part of the fixed period transmits a predetermined request signal that asks a response, and the response is given while the communication apparatus is in sleep mode, the communication apparatus cannot receive the response. Another problem is that the communication apparatus that sends the response wastefully repeats the response until the response is received by the communication apparatus even if the communication apparatus is in sleep mode.

The present invention enables, in a system in which communication apparatuses communicate with each other in a fixed period, a communication apparatus to receive a response signal responding to a request signal transmitted by another communication apparatus.

### SUMMARY OF INVENTION

According to a first aspect of the present invention, a communication apparatus capable of transmitting or receiving a radio signal to or from another communication apparatus in a period of a predetermined length that comes at predetermined time intervals includes a determination unit configured to determine a first period, which is part of a plurality of the periods, to be a period in which the radio signal is transmitted or received, and a second period, which is remaining part, to be a period in which no radio signal is transmitted or received, a transmission unit configured to transmit a request signal to the other communication apparatus in the first period determined by the determination unit, and a control unit configured to, if a response signal responding to the request signal is not received in the first period, control the communication apparatus so as to receive the radio signal also in the second period.

According to a second aspect of the present invention, a communication apparatus capable of transmitting or receiving a radio signal to or from another communication apparatus in a period of a predetermined length that comes at predetermined time intervals includes a determination unit configured to determine a first period, which is part of a plurality of the periods, to be a period in which the radio signal is transmitted or received, and a second period, which is remaining part, to be a period in which no radio signal is transmitted or received, and a transmission unit configured to transmit a request signal for requesting a response signal from the other communication apparatus, the request signal including information indicating the first period, to the other communication apparatus.

Further features of the present invention will become apparent from the following description of exemplary embodiments with reference to the attached drawings.

### BRIEF DESCRIPTION OF DRAWINGS

FIG. 1 is a diagram illustrating the configuration of a communication system.

FIG. 2 is a block diagram illustrating the functional configuration of NAN devices 101 to 103.

FIG. 3 is a flowchart illustrating the operation of the NAN device 102.

FIG. 4 is a flowchart illustrating the operation of the NAN device 101.

FIG. 5 is a diagram illustrating the sequence of the communication system.

FIG. 6 is a flowchart illustrating the operation of the NAN device 102.

FIG. 7 is a flowchart illustrating the operation of the ]NAN device 101.

FIG. 8 is a diagram illustrating the sequence of the communication system.

FIG. 9 is a diagram illustrating the configuration of a frame used in the present embodiment.

### DESCRIPTION OF EMBODIMENTS

Embodiments of the present invention will be described hereinbelow with reference to the drawings. In the following description, although the communication apparatuses are terminals having a wireless LAN communication function based on the IEEE802.11 standard series, this is given for illustrative purpose only. Although the communication apparatuses are neighbor awareness network (NAN) devices that communicate with each other by Wi-Fi neighbor awareness networking to discover other communication apparatuses and services, this is given for illustrative purpose only. In other words, although the following descriptions use technical terms of a given standard, the following descriptions may be applied to other standards of the same type. The NANs communicate service information in a period called Discovery Window (hereinafter referred to as “DW”). The DW is a period of a predetermined length that comes at predetermined time intervals, in which a plurality of devices that execute the NAN converge. A group of terminals that share the DW schedule is referred to as a NAN cluster.

How frequently radio signals are received in the DW periods depends on each NAN device. However, all NAN devices belonging to the NAN cluster need to be in a state in which radio signals can be received (hereinafter referred to as “awake mode”) during a particular DW period called DW0. DW0 is a DW period that comes every 16 DW periods. DW0 is also a DW period starting from the time at which the lower 23 bits of a time synchronization function (TSF), which is a counter timer that the NAN cluster uses for synchronization, is 0×0. 16 DW periods from DW0 to DW15 are repeated at predetermined intervals. In other words, a DW period after 16 DWn (n is an integer from 0 to 15) is also DWn. DW occurs at regular intervals.

The individual devices constituting the NAN cluster act as any one of Master, Non-Master Sync, and Non-Master Non-Sync. A device that acts as Master transmits a synchronization beacon (hereinafter referred to as “Sync beacon”) for each device to identify DW and to synchronize with each other. A device that acts as Master transmits a Discovery beacon, which is a signal for making devices that do not belong to the NAN cluster recognize the NAN cluster. The Discovery beacon is transmitted every 100 ms outside the period of DW. In each NAN cluster, at least one device has to act as Master.

A device acting as Non-Master Sync transmits a Sync beacon but does not transmit a Discovery beacon. A device acting as Non-Master Non-Sync transmits neither of the Sync beacon and the Discovery beacon.

Devices belonging to the NAN cluster synchronize with DW periods of a predetermined cycle in response to a Sync beacon and communicates service information in the DW periods. However, the device acting as Non-Master Non-Sync does not need to perform communication in all DW periods.

The devices communicate a Subscribe message, which is a signal for discovering or requesting a service in the DW periods, and Publish message, which is a signal for reporting provision of a service with each other. Furthermore, the devices can send and receive Follow-up message for exchanging additional information on the service in the DW periods. The Subscribe, Publish, and Follow-up messages are collectively referred to as a service discovery frame (SDF). The devices can publicize or detect services by exchanging SDFs. An NAN device that sends a Subscribe message, which is a service search request message for searching for a service that another device provides, is referred to as Subscriber. A NAN device that sends a Publish message, which is a service provision message for providing a service, is referred to as Publisher.

As described above, NAN devices go to sleep mode in which no radio signal is transmitted and received also in the DW periods to reduce power consumption. Meanwhile, such NAN devices cannot send and receive a Subscribe message and a Publish message in the DW periods in which the NAN devices are in sleep mode. This can increase the period until a service provided by the NAN device is discovered by another NAN device.

In contrast, some NAN device can request service search and notification, such as Subscribe or Publish, from another NAN device. In the present embodiment, a specific NAN device that acts for service search and notification of another NAN device is referred to as “proxy server” (hereinafter referred to as Proxy Server). A specific NAN device that requests proxy processing from another NAN device is referred to as “proxy client” (hereinafter referred to as Proxy Client). When Proxy Server is requested from Proxy Client to transmit service information by proxy, Proxy Server transmits the service information of Proxy Client by proxy. Since Proxy Server executes service search and notification in place of Proxy Client, Proxy Client can stay in sleep mode for a long time, thereby reducing significant power consumption. Furthermore, when an NAN device that searches for a service provided by Proxy Client sends a Subscribe message, Proxy Server may send a response while Proxy Client is in sleep mode. This increases the possibility that the NAN device that searches for a service can discover the service provided by Proxy Client even if Proxy Client is in sleep mode because Proxy Server sends a response in place of Proxy Client.

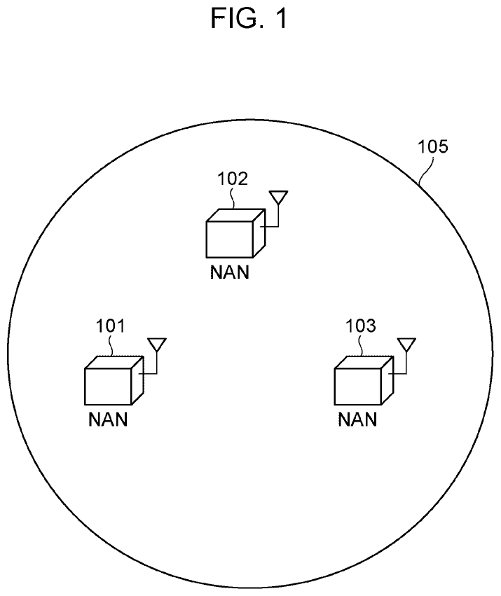

FIG. 1 illustrates an example network configuration of the present embodiment.

NAN devices 101, 102, and 103 are communication apparatuses that perform communication based on the NAN standard. Examples of the communication apparatuses include smartphones, tablet terminals, personal computers (PCs), digital cameras, printers, various digital home appliances, and various sensor devices, but include other apparatuses. The NAN devices 101 to 103 are capable of discovering neighboring communication apparatuses and services provided by the neighboring communication apparatuses and publicizing services that the NAN devices 101 to 103 provide in accordance with the NAN standard. In FIG. 1, the NAN devices 101 to 103 form an NAN cluster 105. The NAN devices 101 to 103 belonging to the NAN cluster 105 communicate with each other on ch. 6 (2.437 GHz) in 2.4 GHz frequency band. In the NAN cluster 105, DWs in 16 time units (TUs) are provided every 512 TUs. The NAN devices 101 to 103 forming the NAN cluster 105 synchronize in DW schedule in accordance with a Sync beacon transmitted and received in DWs. 1 TU is 1,024 μsec. The NAN devices 101 to 103 forming the NAN cluster 105 communicate service information in each DW period using SDF.

The NAN device 101 is a communication apparatus capable of executing the following processes. The NAN device 101 is capable of discovering neighbor communication apparatuses and services provided by the neighbor communication apparatuses and providing information on services that the NAN device 101 can provide in accordance with the NAN standard. The NAN device 101 belongs to the NAN cluster 105 as Master.

The NAN device 102 is a communication apparatus belonging to the NAN cluster 105 as Non-Master Non-Sync. The NAN device 102 searches for a printer service. In the present embodiment, the NAN device 102 goes to awake mode only in DW0 and DW3, in which the NAN device 102 transmits and receives radio signals, and is in sleep mode during other DWs and a period other than DWs. The NAN device 103 acts as Publisher, which is a device capable of providing the printer service that NAN device 102 searches for. The NAN devices 101 to 103 are in sleep mode during DW periods in which no radio signal is transmitted and received. The NAN devices 101 to 103 in sleep mode operate with lower power consumption than in awake mode by not supplying power to a communication unit 206 (described below).

The roles of the NAN devices 101 to 103 described above are given for mere illustrative purposes, and the NAN devices 101 to 103 may act as another role. For example, the NAN device 102 may act as Publisher which sends a Publish message, which is a service provision signal for providing a service.

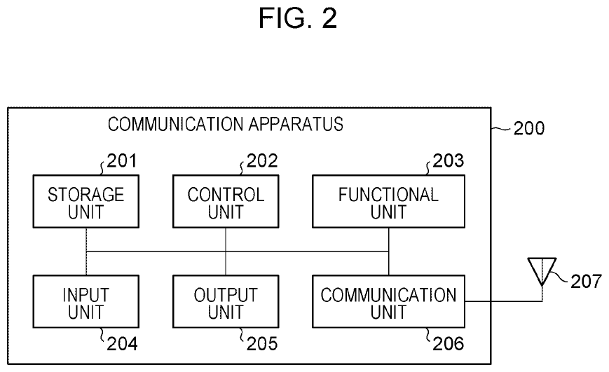

Next, the hardware configuration of the NAN devices 101 to 103 will be described with reference to FIG. 2. FIG. 2 is a diagram illustrating the hardware configuration of the communication apparatus 200 (NAN devices 101 to 103).

A storage unit 201 is a memory, such as a read-only memory (ROM) or a random-access memory (RAM), and stores programs for executing various operations described below and various information, such as communication parameters for wireless communication. In addition to the ROM and RAM, other examples of the storage unit 201 include a flexible disk, a hard disk, an optical disk, a magnetooptical disk, a compact disc read-only memory (CD-ROM), a compact disc recordable (CD-R), magnetic tape, a non-volatile memory card, a digital versatile disc (DVD), and other storage media. The storage unit 201 may include a plurality of memories.

A control unit 202 is a processor, such as a central processing unit (CPU) or a micro-processing unit (MPU), and controls the entire communication apparatus 200 by executing the programs stored in the storage unit 201. The control unit 202 may be a multi-core processor including a plurality of processors and may control the entire communication apparatus 200 with the plurality of processors.

The control unit 202 controls a functional unit 203 to execute predetermined processing, such as image capturing, printing, and projection. The functional unit 203 is hardware for the communication apparatus 200 to execute the predetermined processing. If the communication apparatus 200 is a camera, the functional unit 203 is an image capturing unit for executing image capturing. If the communication apparatus 200 is a printer, the functional unit 203 is a printing unit for executing printing. If the communication apparatus 200 is a projector, the functional unit 203 is a projection unit for executing projection. Data that the functional unit 203 processes may be data stored in the functional unit 201 or data obtained by communicating with another communication apparatus via the communication unit 206.

An input unit 204 receives various operations from the user. An output unit 205 produces various outputs to the user. The outputs produced by the output unit 205 include at least one of display on a screen, an audio output using a speaker, and a vibration output. Both of the input unit 204 and the output unit 205 may be implemented by one module, such as a touch panel. For the display output, the output unit 205 is, for example, a liquid crystal display (LCD) or a light emitting diode (LED) display, and outputs information that the user can visually recognize to display various user interfaces (UIs).

The communication unit 206 includes a chipset for communication based on the Institute of Electrical and Electronic Engineers (IEEE) 802.11 series. The communication unit 206 controls wireless communication and Internet protocol (IP) communication. The communication unit 206 controls an antenna 207 to transmit and receive radio signals for wireless communication. The communication apparatus 200 communicates contents, such as image data, document data, and video data, with other communication apparatuses 200 via the communication unit 206.

Next, embodiments of the processing procedure of the NAN devices 101, 102, and 103, described above, and the sequence of the wireless communication system will be described.

### First Embodiment

In the present embodiment, the NAN device 102 requests the NAN device 101 to search for a service in place of the NAN device 102. If there is no response to the request, the NAN device 102 stays in awake mode even in DW in which the NAN device 102 is to be in sleep mode.

In the present embodiment, the NAN device 101 can act as Proxy Server capable of acting as a proxy for another NAN device in service search and notification. The NAN device 102 has the function of Proxy Client, and when discovering Proxy Server, the NAN device 102 can request service search and notification by proxy. Proxy Server lists the results of the proxy search in a Publisher list. If the NAN device 102 is Publisher, the results are listed in a Subscriber list. The Publisher list or Subscriber list sent from Proxy Server to Proxy Client in response to a request from Proxy Client.

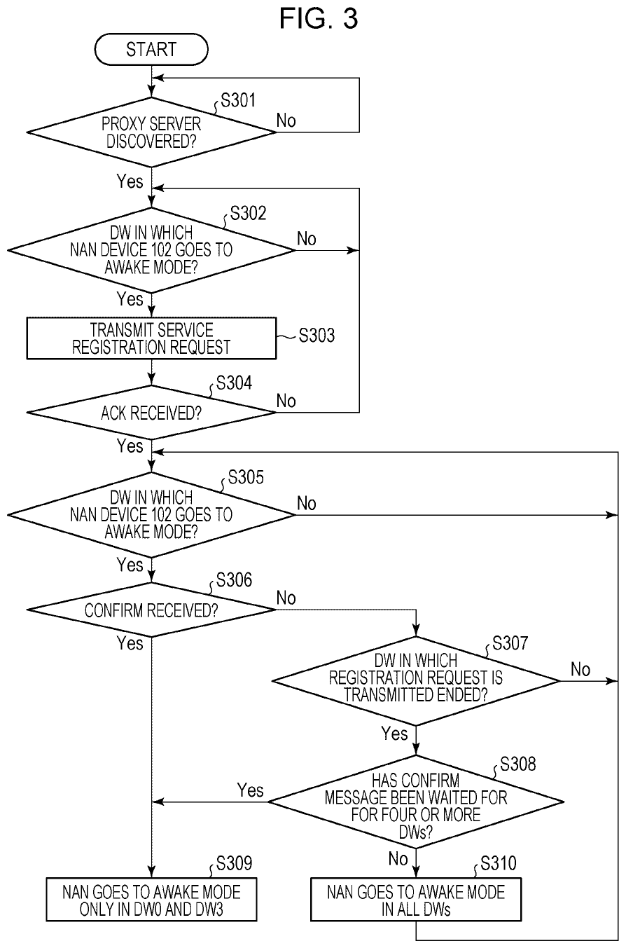

The operation of the NAN device 102 when the NAN device 101 perform service search by proxy in the NAN cluster 105 will be described with reference to the flowchart in FIG. 3.

The flowchart of FIG. 3 is started when the NAN device 102 participates in the NAN cluster 105 and starts an operation as Proxy Client. The flowchart in FIG. 3 is executed by the control unit 202 of the NAN device 102 executing a control program stored in the storage unit 201 to execute computation and processing of information and control of each hardware component. Part or all of the steps of the flowchart in FIG. 3 may be implemented by hardware, such as an application-specific integrated circuit (ASIC).

The NAN device 102 initially acts as Proxy Client. Specifically, the NAN device 102 notifies neighboring devices that the NAN device 102 can act as Proxy Client using a Subscribe message (Proxy Service). Another method may be used to give the notification that the NAN device 102 can act as Proxy Client. For example, information indicating that the NAN device 102 can act as Proxy Client may be included in a Sync beacon. The information indicating that the NAN device 102 can act as Proxy Client may be included in a Subscribe message for use in service search.

Referring to FIG. 3, the NAN device 102 determines whether the NAN device 101 that acts as Proxy Server is discovered (S301). The operation of the NAN device 102 acting as Proxy Client may be started on condition that a positive determination is made at S301. The NAN device 102 determines whether it is DW0 or DW3 when the NAN device 102 goes to awake mode (S302). The NAN device 102 is in sleep mode during a period other than DW0 and DW3 (the other DW periods and a period other than DWs). In DW0 or DW3, the NAN device 102 shifts from sleep mode to awake mode and transmits a service registration request to the NAN device 101 discovered at S301 (S303). The NAN device 102 determines whether an acknowledgement (ACK), which is a service registration request reception confirmation signal, has been sent from the NAN device 101 (S304). If no, the NAN device 102 transmits the service registration request again. Reception of ACK indicates that the NAN device 101, which is Proxy Server, has received the service registration request. Proxy Server sends a confirm message to the NAN device 102 in response to the received service registration request to indicate that Proxy Server starts service search by proxy. The confirm message is a response signal responding to the service registration request and indicates that the requested service registration has been completed. After transmitting the service registration request, the NAN device 102 determines whether the NAN device 102 has received the confirm message (S306). If having received the confirm message, the NAN device 102 goes to awake mode only in DW0 and DW3 to continue the service search (S309). At that time, the NAN device 102 may delegate the service search to the Proxy Server and leave the NAN cluster 105. If the NAN device 102 has received no confirm message, then the NAN device 102 determines whether the DW in which the service registration request is transmitted has ended (S307). If it is the DW in which the service registration request is transmitted, the NAN device 102 continues to wait for reception of the confirm message. If the DW in which the service registration request is transmitted ends, the NAN device 102 determines whether the NAN device 102 has waited for the confirm message for a period of a threshold or more, for example, four DWs (S308). If not having waited for the threshold time or more, the NAN device 102 goes to awake mode also in DW, such as DW1 or DW2 (DW other than DW0 and DW3) in which the NAN device 102 is to be in sleep mode, and continues to wait for reception of the confirm message (S310). If having waited for the threshold time or more, the NAN device 102 determines that no confirm message is sent and goes to awake mode only in DW0 and DW3 to continue the service search (S309). At that time, the NAN device 102 may search for another NAN device acting as Proxy Server. The NAN device 102 may perform service search only by the NAN device 102 itself without using Proxy. The NAN device 102 may transmit the service registration request to Proxy Server again in DW in which the NAN device 102 normally goes to awake mode. The threshold of the time during which reception of the confirm message is waited for is not limited to four DWs but may be another number of DMs or variable values. For example, if no response is given in four DWs, the NAN device 102 may wait for eight DWs. Conversely, when continuously receiving immediate response, the waiting time may be changed to two DWs. This allows efficient determination of the waiting time until the NAN device 102 receives a response.

The operation of the NAN device 102 illustrated in the flowchart of FIG. 3 is not limited to the operation in transmitting a service registration request and receiving a confirm message. For example, the same operation may be performed when the NAN device 102 requests a Publisher list, and the NAN device 101 sends a Publisher list in response. In this case, the operation in S303 is an operation for transmitting a request for a Publisher list. The operation in S305 is an operation for determining whether a Publisher list has been received. Another message before communication is performed outside DW may be transmitted and received. For example, the operation at S303 is transmission of a message on candidate periods other than DW. In this case, a message waited for at S305 is a message chosen from the candidate periods other than DW. If the operation at S303 is transmission of a message on a chosen period other than DW, a message waited for at S305 is a message indicating the chosen period other than DW. Thus, the flowchart in FIG. 3 is employed when a request signal and a response signal are exchanged in DW, and when one or both of the NAN devices 101 and 102 are normally in sleep mode in part of DWs. In such cases, the NAN devices 101 and 102 are not necessarily Proxy Server and Proxy Client, respectively. For example, the NAN devices 101 and 102 may be used as Non-Master Non-Sync that does not perform Proxy processing.

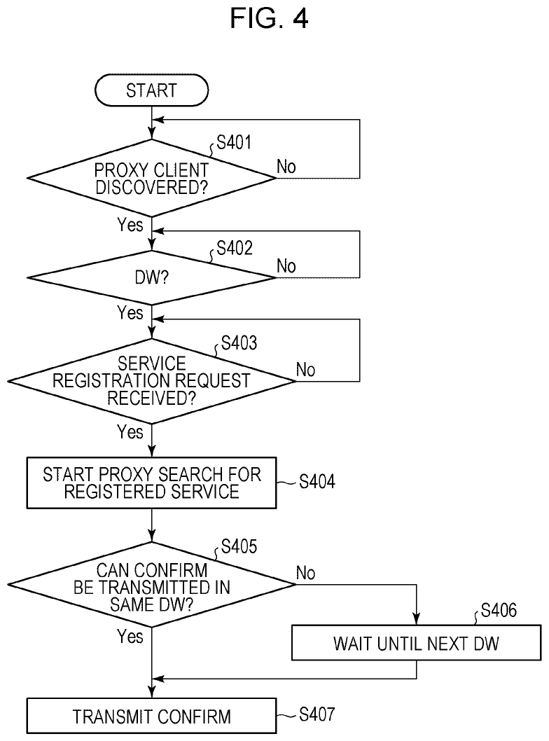

Next, the operation of the NAN device 101 after receiving the service registration request until sending the confirm message in response will be described with reference to the flowchart illustrated in FIG. 4. The signals transmitted and received in the operation of FIG. 4 correspond to the signals transmitted and received in the flowchart in FIG. 3, respectively.

The flowchart in FIG. 3 is started when the NAN device 101 participates in the NAN cluster 105 and starts an operation as Proxy Server. The flowchart in FIG. 4 is executed by the control unit 202 of the NAN device 101 executing a control program stored in the storage unit 201 to execute computation and processing of information and control of each hardware component. Part or all of the steps of the flowchart in FIG. 4 may be implemented by hardware, such as an ASIC.

The NAN device 101 initially acts as Proxy Server. Specifically, the NAN device 101 notifies neighboring devices that the NAN device 101 can act as Proxy Server using a Publish message (Proxy Service). Another method may be used to give the notification that the NAN device 101 can act as Proxy Server. For example, information indicating that the NAN device 101 can act as Proxy Server may be included in a Sync beacon. The information indicating that the NAN device 101 can act as Proxy Server may be included in a Publish message for use in service search.

Referring to FIG. 4, the NAN device 101 determines whether the NAN device 102 that acts as Proxy Client is discovered (S401). The operation of the NAN device 101 acting as Proxy Server may be started on condition that a positive determination is made at S401. If having discovered Proxy Client, the NAN device 101 waits until DW (S402). Next, the NAN device 101 determines whether the NAN device 101 has received a service registration request (S403). If having received the service registration request, the NAN device 101 prepares, as Proxy Server, to execute the service requested by the received service registration request (S404). In this example, the service search processing is requested by the service registration request. Upon completion of preparation for proxy search, the NAN device 101 sends a confirm message to the NAN device 102. The NAN device 101 determines whether the confirm message can be sent in the DW in which the service registration request is received (S405). If the confirm message can be sent in the same DW, the NAN device 101 sends the confirm message in the DW (S407). If no, the NAN device 101 waits to send the confirm message until the next DW (S406). Thereafter, in the next DW, the NAN device 101 sends the confirm message (S407). Step S404 and steps S406 to S407 may be independently performed. Steps S405 to S407 may be performed before S404.

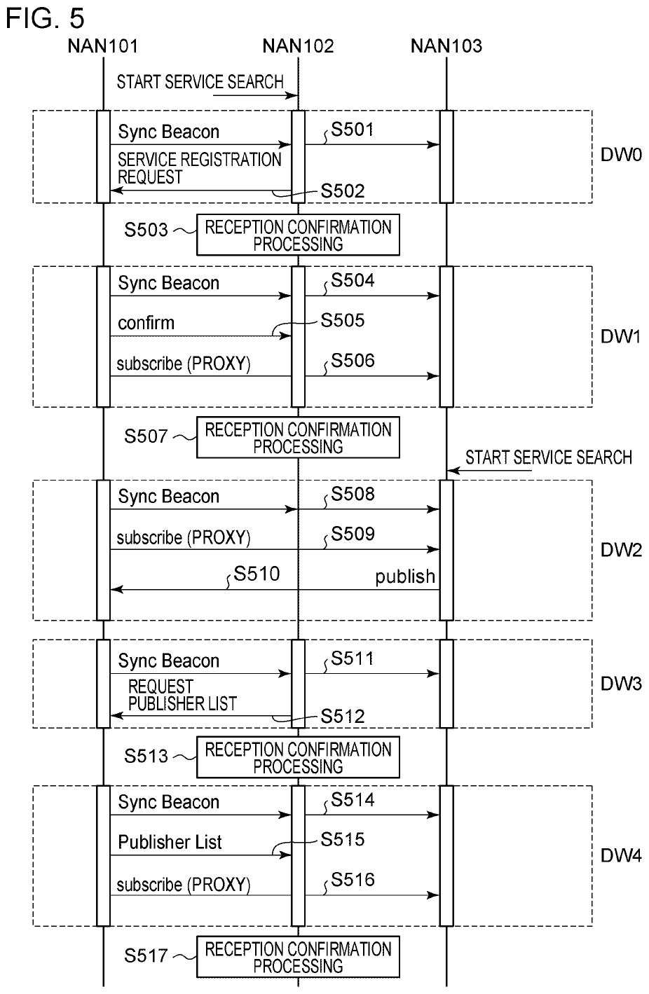

Next, a sequence after the NAN device 102 acting as Subscriber registers Subscribe in the NAN device 101 until receiving a Publisher list will be described with reference to FIG. 5. In this case, the confirm message and the Publisher list are sent in DW different from the DW in which the NAN device 102 sent the request signal.

In FIG. 5, the NAN device 102 is normally in awake mode in DW0 and DW3, and in sleep mode in a period other than DW0 and DW3. The NAN device 101 and the NAN device 103 are in awake mode in all the DWs and are in sleep mode in the other period. The NAN device 103 sends a Publish message in DW2.

The NAN device 102 starts service search. When it becomes DW0, the NAN device 102 confirms that the NAN device 101 acting as Proxy Server exists nearby and sends a service registration request (S502). Upon receiving the service registration request, the NAN device 101 starts to prepare for proxy search and sends a confirm message to the NAN device 102 acting as Proxy Client. However, the confirm message is sent not in DW0 but in DW1 (S505). Since the NAN device 102 has not yet received the confirm message at the point when DW0 ends, the NAN device 102 determines to be in awake mode also in DW1 in which the NAN device 102 is originally in sleep mode (S503). In DW1, the NAN device 101 sends a confirm message (S505). Upon confirming the confirm message, the NAN device 102 returns to normal mode and determines to go to sleep mode in the next DW2 (S507). In DW2, the NAN device 101 receives a Publish message from the NAN device 103 and stores the NAN device 103 as a candidate of the communication partner of the NAN device 102 (S510). In DW3, the NAN device 102 requests a Publisher list from the NAN device 101 (S512). Since not having received the Publisher list at the end of DW3, the NAN device 102 determines to stay in awake mode even in DW4, in which the NAN device 102 is originally in sleep mode (S513). In DW4, the NAN device 101 sends a Publisher list (S515). Upon confirming the Publisher list, the NAN device 102 returns to normal mode and determines to go to sleep mode in the next DWS (S517).

Thus, even if the NAN device 102 fails to receive a response signal responding to a request signal, the NAN device 102 can receive the response signal transmitted in the next DW by keeping the awake mode also in the next DW, in which the NAN device 102 is originally in sleep mode. This also prevents the sender of the response signal from wastefully repeating sending the response signal because ACK to the response signal is not sent. This also allows the unit waiting for the response signal to stay in sleep mode in the period other than the DW period while waiting for the response signal, allowing waiting for the response signal with lower power consumption than that in keeping awake mode the time.

### Second Embodiment

In the present embodiment, the service search request by proxy that the NAN device 102 sends to the NAN device 101 includes information on DW in which signals can be transmitted and received (hereinafter referred to as “awake time”). Description of the same parts as those of the first embodiment will be omitted.

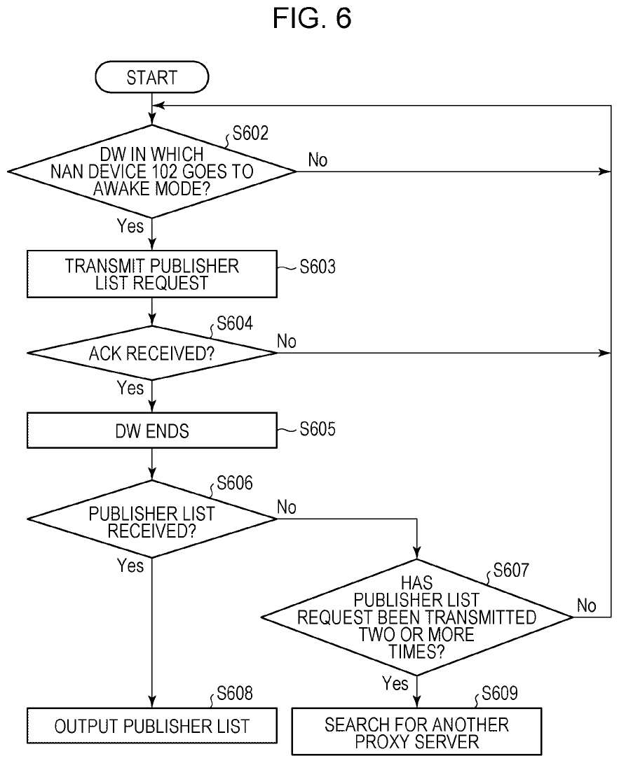

The operation of the NAN device 102 when the NAN device 101 performs service search by proxy in the NAN cluster 105 will be described with reference to the flowchart in FIG. 6.

The flowchart of FIG. 6 is started when the NAN device 102 participates in the NAN cluster 105 and requests, as Proxy Client, a Publisher list from Proxy Server in accordance with an instruction of the user. This flowchart may be executed at regular intervals from the time the service is registered in Proxy Server. The operation may be automatically triggered when a certain event occurs. The flowchart in FIG. 6 is executed by the control unit 202 of the NAN device 102 executing a control program stored in the storage unit 201 to execute computation and processing of information and control of each hardware component. Part or all of the steps of the flowchart in FIG. 6 may be implemented by hardware, such as an ASIC.

The NAN device 102 initially acts as Proxy Client. The NAN device 102 waits until DW in which the NAN device 102 goes to awake mode (S602). In the DW in which the NAN device 102 goes to awake mode, the NAN device 102 sends a request for a Publisher list including awake time to the NAN device 101 (S603). Next, the NAN device 102 determines whether ACK responding to the request for the Publisher list has been sent (S604). If no, the NAN device 102 sends the Publisher list request again. After sending the Publisher list request, the NAN device 102 determines whether the Publisher list has been received in the same DW (S606). If yes, the NAN device 102 outputs the received Publisher list to the output unit 205 (S608). By outputting the Publisher list to the output unit 205, the user can choose a desired Publisher from the output Publisher list. Alternatively, the NAN device 102 may automatically choose Publisher in accordance with certain conditions, instead of the user choosing a Publisher. In this case, the NAN device 102 may not output the Publisher list to the output unit 205 and may output the chosen Publisher instead of the Publisher list. The NAN device 102 may not choose Publisher (a communications partner) from the Publisher list received this time and may send the Publisher list request again in the next or subsequent DW.

If at S606 the NAN device 102 has not received the Publisher list, then the NAN device 102 determines whether the Publisher list request has been sent two times (S607). If no, the NAN device 102 waits until DW in which the NAN device 102 goes to awake mode, and the NAN device 102 sends the Publisher list request again (S603). If the NAN device 102 has already sent the Publisher list request two times, the NAN device 102 searches for another Proxy Server (S609). In this case, the NAN device 102 may perform service search only by the NAN device 102 itself without using Proxy Server. The determination at S607 may be performed with reference to whether the NAN device 102 has waited for a threshold time or more or threshold times of DW. The number of times is not limited to two but may be another number or variable value. The above operations are not limited to the request for a Publisher list and a response to the Publisher list.

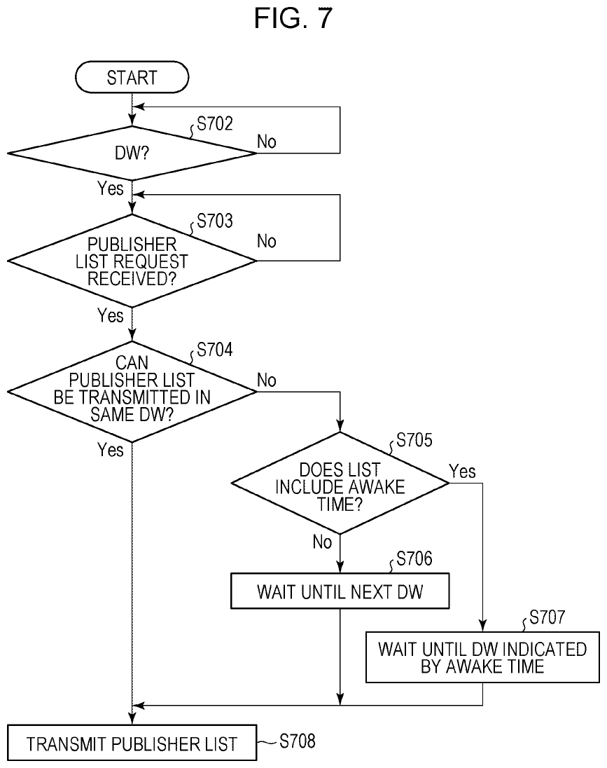

The operation of the NAN device 101 after receiving a Publisher list request until sending a Publisher list in response will be described with reference to the flowchart in FIG. 7. The signals transmitted and received in the operation of FIG. 7 correspond to the signals transmitted and received in the flowchart of FIG. 6, respectively.

The flowchart is started when the NAN device 101 participates in the NAN cluster 105 and starts an operation, as Proxy Server, for searching for a service in place of Proxy Client. The flowchart in FIG. 7 is executed by the control unit 202 of the NAN device 101 executing a control program stored in the storage unit 201 to execute computation and processing of information and control of each hardware component. Part or all of the steps of the flowchart in FIG. 7 may be implemented by hardware, such as an ASIC.

The NAN device 101 initially acts as Proxy Server. The NAN device 101 waits for reception of a Publisher list request in DW (S703). If the NAN device 101 has received a Publisher list request, then the NAN device 101 determines whether a Publisher list can be sent in the DW in which the Publisher list request is received (S704). If the Publisher list can be sent, the NAN device 101 sends the Publisher list in the DW (S708). If the Publisher list cannot or could not be sent in the DW, the NAN device 101 determines whether the Publisher list includes awake time (S705). If no, the NAN device 101 waits until the next DW (S706), in which the NAN device 101 sends the Publisher list (S708). If awake time is included, the NAN device 101 analyzes the information and waits until DW in which Proxy Client goes to awake mode next (S707). Even if no request is sent from Proxy Client again in the DW in which the Proxy Client goes to awake mode, the NAN device 101 sends the Publisher list (S708).

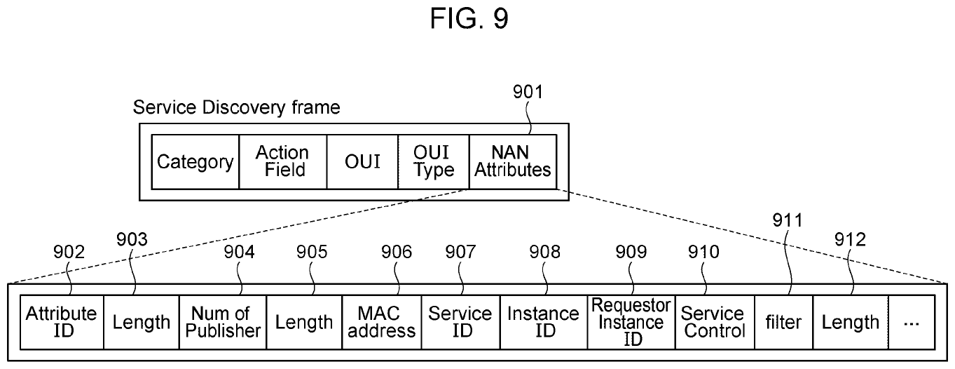

FIG. 9 illustrates an example frame configuration of a Publisher list, which is a Service Discovery frame (SDF) that Proxy Server sends. The SDF is a public action frame based on the IEEE802.11 standard. The SDF includes, in part of the public action frame, NAN Attributes 901 indicating information defined by the NAN. Attribute ID 902 indicating the type of information is a value of 0x16, which indicates that the information indicates publisher list attributes. This may be another value. Num of Publisher 904 is the number of corresponding Publishers. If there is no corresponding Publisher, a value of 0 is sent to Proxy Client. The following Length 905 is the length of information on each Publisher. Mac address 906 is the media access control address (MAC) address of the Publisher. Items from Service ID 907 to filter 911 are information included in the Publish message. From Length 912, information on each Publish message continues as from 905 to 911. The above frame configuration is given for illustrative purpose only, and any configuration may be used. For example, different NAN Attribute may be added. This allows transmitting Proxy information in addition to the Publisher list to Proxy Client.

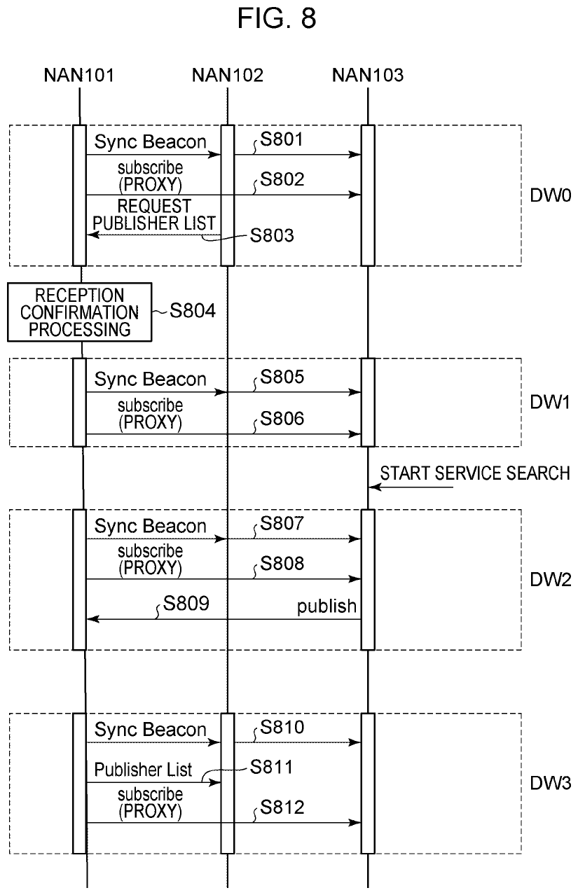

Next, referring to FIG. 8, a sequence after the NAN device 102 acting as Subscriber sends a Publisher list request until receiving a Publisher list will be described. In this case, the Publisher list is sent in DW different from the DW in which the NAN device 102 sent the request signal.

In FIG. 8, the NAN device 102 is normally in awake mode in DW0 and DW3, and in sleep mode in a period other than DW0 and DW3. The NAN device 101 and the NAN device 103 are in awake mode in all the DWs, and in sleep mode in the other period. The NAN device 103 sends a Publish message in DW2.

In DW0, the NAN device 102 sends a request for a Publisher list including awake time (S803). Upon receiving the Publisher list request, the NAN device 101 determines whether the Publisher list can be sent in DW0 (S804). Since the determination shows that the Publisher list cannot be sent in DW0, the NAN device 101 does not send the Publisher list until DW3 in accordance with the operation in FIG. 7.

In DW2, the NAN device 103 sends Publish. Upon receiving Publish, the NAN device 101 stores information on the NAN device 103 as a candidate of the communication partner of the NAN device 102.

When it becomes DW3, the NAN device 102 goes to awake mode as indicated by awake time. Since DW3 is DW in which the NAN device 102 goes to awake mode, the NAN device 101 sends a Publisher list. The NAN device 101 sends the Publisher list even without receiving a Publisher list request from the NAN device 102. At that time, the NAN device 101 may send the Publisher list including information on the NAN device 103 detected in DW2.

Thus, adding awake time to the frame that requires a response offers the following advantages. The NAN device 102 can reliably receive the Publisher list even in sleep mode in a period other than DWs in which the NAN device 102 goes to awake mode. Furthermore, there is no need to send the Publisher list request again in DW3. Furthermore, since the NAN device 101 can analyze the awake time of the NAN device 102, there is no need to wastefully send the Publisher list in DW in which the NAN device 102 is in sleep mode, such as DW1 and DW2. Since the NAN device 102 stays in sleep mode in DWs in which the NAN device 102 is originally in sleep mode, power consumption can be reduced more than that in the first embodiment.

### Other Embodiments

In the above embodiments, although the NAN device 102 goes to awake mode in DW0 and DW3, and is in sleep mode in the other DWs, the NAN device 102 may go to awake mode in the other DWs. In the above embodiments, the NAN device 101 acts as Proxy Server for searching for a service that the NAN device 102 requests. However, information transmitted using Proxy function is not limited to service search information. For example, the NAN device 101 may receive a notification about a service provided by another NAN device and may send the notification about the service in place of the NAN device. In this case, the NAN device 101 can search for the service by sending a Publish message from the NAN device by proxy and receiving a Subscribe message or a Follow-up message as a response. The NAN device 101 may wait for a Subscribe message sent (for example, spontaneously) by another NAN device without sending a Publish message. In either case, the NAN device 101 can notify the device that requests proxy service search of the search result in a DW period in which the device can receive a radio signal.

In the above embodiments, although the NAN device 101 receives a Proxy request from the NAN device 102, the NAN device 101 may receive a Proxy request from one or more other NAN devices.

In the second embodiment, although the NAN device 102 sends the request for the Publisher list including awake time, awake time may be included in another frame. Awake time may be included in all frames that the NAN device 102 transmits in DWs in which the NAN device 102 is in sleep mode. Awake time may be included in a frame transmitted when DW in sleep mode or awake mode is changed. Awake time may be included in a frame that requires a response as in the second embodiment. Any combination of the above configurations may be used.

Embodiments of the present invention can also be realized by executing the following processes. The processes are executed by providing software (programs) for implementing the functions of the embodiments to a system or an apparatus via a network or various storage media and by reading the programs with a computer (or a central processing unit [CPU] or a micro processing unit [MPU]) of the system or the apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus capable of transmitting or receiving a radio signal to or from another communication apparatus in a period of a predetermined length that comes at predetermined time intervals, the apparatus comprising:
a determination unit configured to determine a first period, which is part of a plurality of the periods, to be a period in which the radio signal is transmitted or received, and a second period, which is remaining part, to be a period in which no radio signal is transmitted or received;
a transmission unit configured to transmit a request signal to the other communication apparatus in the first period determined by the determination unit; and
a control unit configured to, if a response signal responding to the request signal is not received in the first period, control the communication apparatus so as to receive the radio signal also in the second period.

2. The communication apparatus according to claim 1, wherein the control unit controls the communication apparatus, if a reception confirmation signal responding to the request signal is received, and the response signal is not received, to receive the radio signal also in the second period.

3. The communication apparatus according to claim 1, wherein the other communication apparatus is a proxy server that performs service search or notification in the period as a proxy of the communication apparatus.

4. The communication apparatus according to claim 3, wherein the request signal is a signal for requesting the proxy server to perform proxy processing.

5. The communication apparatus according to claim 1, wherein the communication apparatus and the other communication apparatus form a neighbor awareness networking (NAN) cluster and transmit or receive a radio signal.

6. The communication apparatus according to claim 1, wherein the period of the predetermined length that comes at the predetermined time intervals is a discovery window of the neighbor awareness networking (NAN).

7. The communication apparatus according to claim 1, wherein the communication apparatus operates with lower power consumption in a period other than the period and the second period than in the first period.

8. A communication apparatus capable of transmitting or receiving a radio signal to or from another communication apparatus in a period of a predetermined length that comes at predetermined time intervals, the apparatus comprising:
a determination unit configured to determine a first period, which is part of a plurality of the periods, to be a period in which the radio signal is transmitted or received, and a second period, which is remaining part, to be a period in which no radio signal is transmitted or received; and
a transmission unit configured to transmit a request signal for requesting a response signal from the other communication apparatus, the request signal including information indicating the first period, to the other communication apparatus.

9. The communication apparatus according to claim 8, wherein the other communication apparatus is a proxy server that performs service search or notification in the period as a proxy of the communication apparatus.

10. The communication apparatus according to claim 9, wherein the request signal is a signal for requesting the proxy server to perform proxy processing.

11. The communication apparatus according to claim 8, wherein the communication apparatus and the other communication apparatus form a neighbor awareness networking (NAN) cluster and transmit or receive a radio signal.

12. The communication apparatus according to claim 8, wherein the period of the predetermined length that comes at the predetermined time intervals is a discovery window of the neighbor awareness networking (NAN).

13. The communication apparatus according to claim 8, wherein the communication apparatus operates with lower power consumption in a period other than the period and the second period than in the first period.

14. A method of communication for transmitting or receiving a radio signal between communication apparatuses in a period of a predetermined length that comes at predetermined time intervals, the method comprising:
determining a first period, which is part of a plurality of the periods, to be a period in which the radio signal is transmitted or received, and a second period, which is remaining part, to be a period in which no radio signal is transmitted or received;
transmitting a request signal to another communication apparatus in the first period determined by the determination unit; and
performing control, if a response signal responding to the request signal is not received in the first period, so as to receive the radio signal also in the second period.

15. A method of communication for transmitting or receiving a radio signal between communication apparatuses in a period of a predetermined length that comes at predetermined time intervals, the method comprising:
determining a first period, which is part of a plurality of the periods, to be a period in which the radio signal is transmitted or received, and a second period, which is remaining part, to be a period in which no radio signal is transmitted or received; and
transmitting a request signal for requesting a response signal from another communication apparatus, the request signal including information indicating the first period, the other communication apparatus.

16. A non-transitory computer-readable storage medium storing a computer program for causing a computer to execute a method of controlling a communication apparatus capable of transmitting or receiving a radio signal to or from another communication apparatus in a period of a predetermined length that comes at predetermined time intervals, the method comprising:
determining a first period, which is part of a plurality of the periods, to be a period in which the radio signal is transmitted or received, and a second period, which is remaining part, to be a period in which no radio signal is transmitted or received;
transmitting a request signal to another communication apparatus in the first period determined by the determination unit; and
performing control, if a response signal responding to the request signal is not received in the first period, so as to receive the radio signal also in the second period.

17. A non-transitory computer-readable storage medium storing a computer program for causing a computer to execute a method of controlling a communication apparatus capable of transmitting or receiving a radio signal to or from another communication apparatus in a period of a predetermined length that comes at predetermined time intervals, the method comprising:
determining a first period, which is part of a plurality of the periods, to be a period in which the radio signal is transmitted or received, and a second period, which is remaining part, to be a period in which no radio signal is transmitted or received; and
transmitting a request signal for requesting a response signal from another communication apparatus, the request signal including information indicating the first period, to the other communication apparatus.
